(19) United States
(12) Patent Application Publication
(10) Pub. No.: US 2013/0240089 A1
(43) Pub. Date: Sep. 19, 2013

(54) STAMPING DIE WITH CONNECTING MEMBER

(71) Applicants: HONG FU JIN PRECISION INDUSTRY (SHENZHEN) CO., LT, Shenzhen (CN); HON HAI PRECISION INDUSTRY CO., LTD., New Taipei (TW)

(72) Inventor: JIAN-HUA LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/685,633

(22) Filed: Nov. 26, 2012

(30) Foreign Application Priority Data
Mar. 13, 2012 (CN) 201210064263.X

(51) Int. Cl. B27C 9/00

(52) U.S. Cl. CPC B27C 9/00
USPC 144/196

(57) ABSTRACT

A stamping die includes a bracket, a resilient member, a floating plate, a connecting member, a supporting plate, and a limiting member. The resilient member is secured to the bracket. The supporting plate is secured to the resilient member. A first end of the connecting member is secured to the floating plate. A second end of the connecting member, opposite to the first end, abuts the supporting plate. The limiting member is secured to the bracket. The connecting member defines a cutout. The limiting member is partially received in the cutout. The supporting plate, the connecting member and the floating plate are slidable together relative to the bracket. The limiting member prevents the connecting member and the floating plate from disengaging from the supporting plate and the bracket when the connecting member and the floating plate are slid relative to the bracket.

### BACKGROUND

1. Technical Field

The present disclosure relates to stamping dies, and particularly to a stamping die with a connecting assembly.

2. Description of Related Art

An ejecting device pushes a floating plate, which loads products, out from a stamping die, so as to take the next product. A connecting assembly is located between the ejecting device and the floating plate and movably mounts the ejecting device and the floating plate to a bracket. However, a complex mounting structure is required for the connecting assembly, which may cause an inconvenient mounting for the ejecting device and the floating plate.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a stamping die.

FIG. 2 is an exploded, isometric view of a connecting member of the stamping die of FIG. 1.

FIG. 3 is an isometric view of partially assembled stamping die of FIG. 1.

FIG. 4 is an enlarged view of a circled portion IV of FIG. 3.

FIG. 5 is an assembled view of the stamping die of FIG. 1.

FIG. 6 is a cross-sectional view of the stamping die of FIG. 5 taken along a line VI-VI.

FIG. 7 is an enlarged view of a circled portion VII of FIG. 6.

FIG. 8 is similar to FIG. 6, but shows the stamping die of FIG. 6 in a different state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

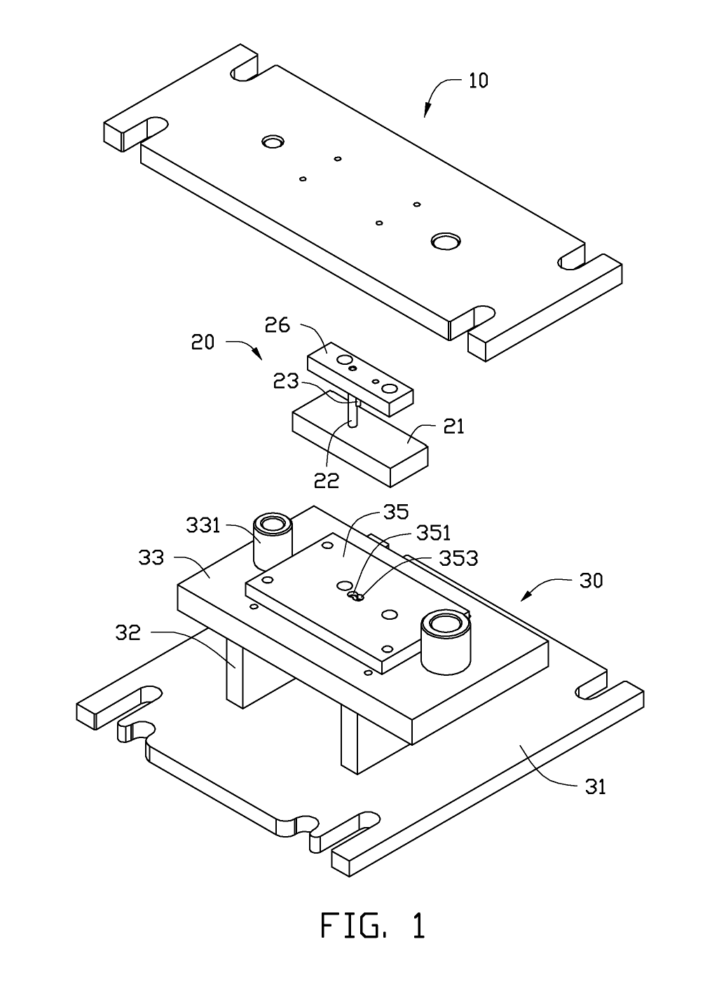

FIG. 1 shows a stamping die in accordance with an embodiment. The stamping die comprises a punching assembly 10, a connecting assembly 20, and a bracket 30.

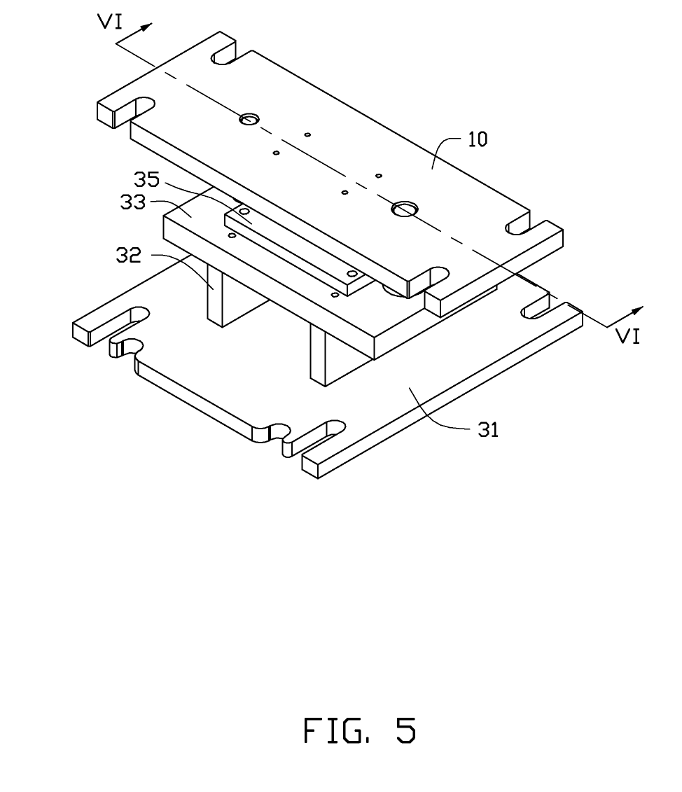

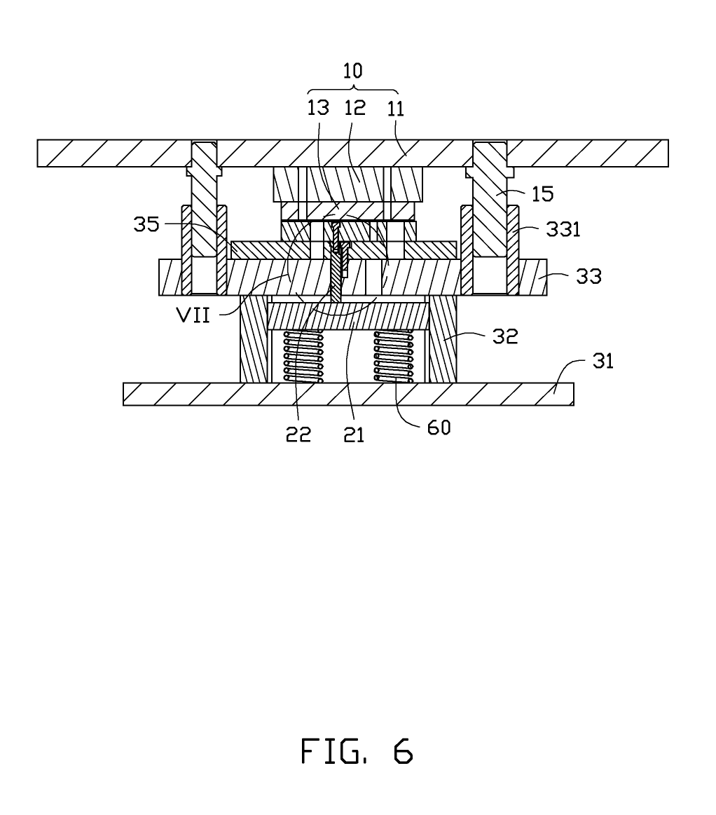

FIG. 5 and FIG. 6 show the punching assembly 10 comprising an upper die holder 11, a top board 12, and a punch head 13.

The upper die holder 11 is connected to a punch (not shown) and moved up and down. The top board 12 is secured to the upper die holder 11 and adapted for supporting the punch head 13. The punch head 13 is secured to the top board 12 and located between the upper die holder 11 and the punch head 13. The punch head 13 is used for punching a flitch. Two sliding posts 15 are secured to the upper die holder 11 and are located on opposite sides of the top board 12 and the punch head 13.

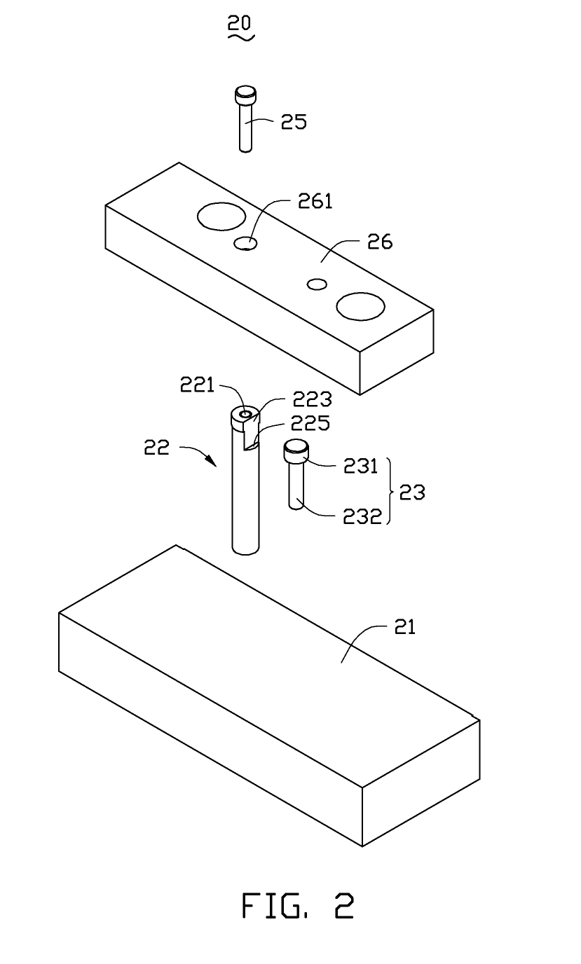

FIG. 2 shows that the connecting assembly 20 comprises a supporting plate 21, a connecting member 22, a limiting member 23, a mounting member 25, and a floating plate 26. The connecting member 22 connects the supporting plate 21 to the floating plate 26. A first end of the connecting member 22 defines a threaded hole 221 and a cutout (not labeled) so as to form a blocking plane 223 and a limiting plane 225. In one embodiment, the blocking plane 223 is substantially perpendicular to the limiting plane 225. The limiting member 23 comprises a limiting portion 231 and a mounting portion 232 connected to the limiting portion 231. In one embodiment, a cross-section of the limiting member 23 is circular. A diameter of the limiting portion 231 is greater than a diameter of the mounting portion 232. The mounting portion 232 defines a plurality of outer threads. The mounting member 25 defines a plurality of outer threads. In one embodiment, each of the limiting member 23 and the mounting member 25 is a screw. The floating plate 26 defines a through hole 261 with inner threads. A size of the through hole 261 is equal to a size of the threaded hole 221. The mounting member 25 can be locked into the threaded hole 221.

The bracket 30 comprises a base 31, two supporting blocks 32, an operating plate 33, and an installation plate 35. The two supporting blocks 32 are perpendicularly secured to the base 31. The operating plate 33 is secured to the two supporting blocks 32. The installation plate 35 is secured to the operating plate 33. Two rams 331 are secured to the operating plate 33, and the installation plate 35 is located between the two rams 331. The installation plate 35 defines an installation hole 351 and a mounting hole 353. The installation hole 351 extends out of the operating plate 33 and receives the connecting member 22. The mounting hole 353 extends to the operating plate 33 and secures the limiting member 23. The installation hole 351 is adjacent to the mounting hole 353. Apart of the installation hole 351 communicates with a part of the mounting hole 353.

FIG. 6 shows that the stamping die further comprises two resilient members 60. The two resilient members 60 can be mounted in the bracket 30. In one embodiment, each of the two resilient members 60 is a spring.

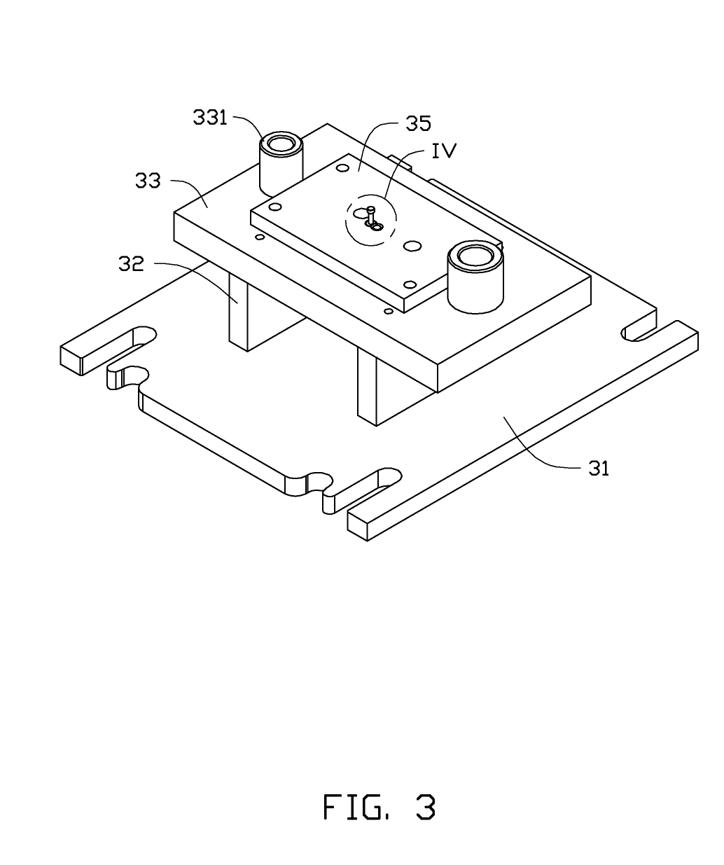

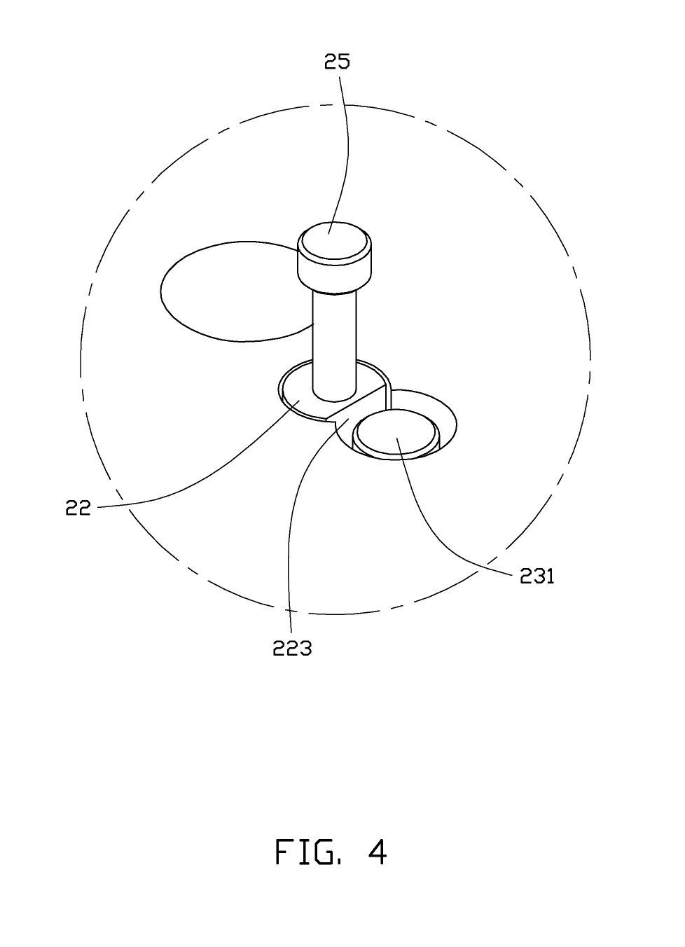

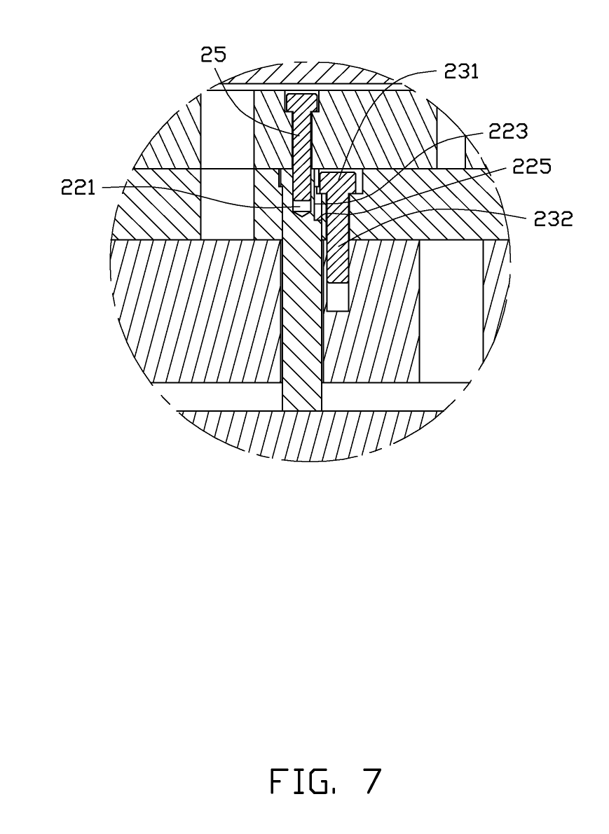

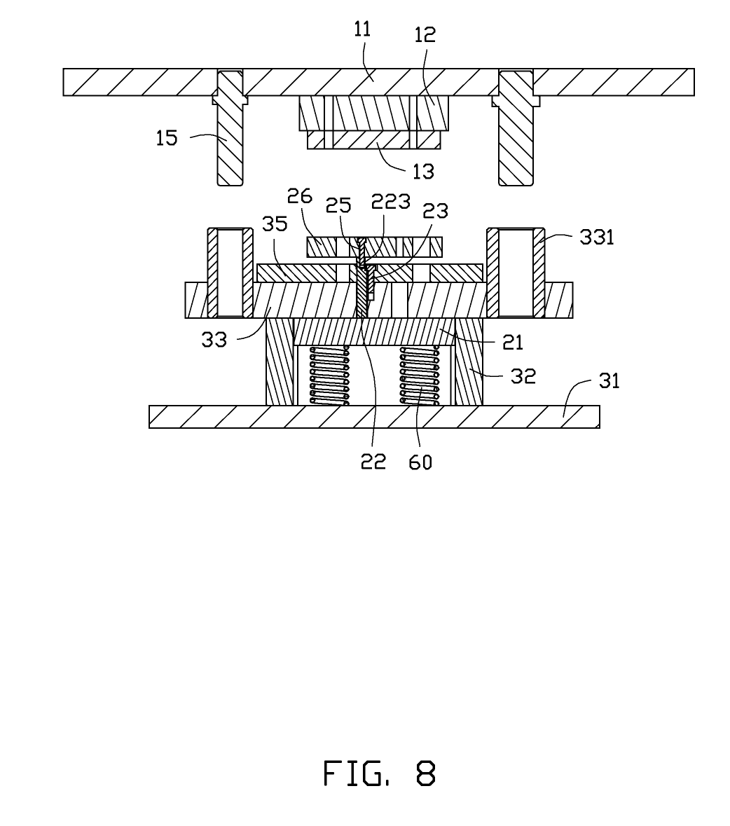

FIGS. 3-8 show that, in assembly, the supporting plate 21 is positioned between the two supporting blocks 32. The two resilient members 60 are secured between the supporting plate 21 and the base 31. The first end of the connecting member 22 is received in the installation hole 351. A second end of the connecting member 22 abuts the supporting plate 21 through the installation hole 351. The limiting member 23 is locked in the mounting hole 353. A part of the limiting portion 231 is received in the cutout, and an outer surface of the limiting portion 231 abuts the blocking plane 223. The limiting plane 225 is located under the limiting portion 231. The floating plate 26 is located on the installation plate 35. The mounting member 25 is locked in the threaded hole 221 and the through hole 261. When the mounting member 25 is inserted into the threaded hole 221, the limiting portion 231 prevents the connecting member 22 from being rotated by the mounting member 25. Thus, the mounting member 25 connects the floating plate 26 to the supporting plate 21. The floating plate 26, the connecting member 22, and the supporting plate 21 are slidable together relative to the bracket 30. The punching assembly 10 is positioned above the floating plate 26, and the two sliding posts 15 are aligned with the two rams 331. The upper die holder 11 is secured to the punch. In this position, each of the two resilient members 60 is minimally compressed.

In use, the flitch is placed on the floating plate 26. The punching assembly 10 is moved towards the floating plate 26 by the punch. When the punch head 13 abuts the flitch, the punching assembly 10 moves the floating plate 26, the connecting member 22, and the supporting plate 21 towards the two resilient members 60, until the floating plate 26 presses on the installation plate 35. In this position, each of the two resilient members 60 undergoes maximum compression. The punching assembly 10 is moved away from the floating plate 26. The two resilient members 60 rebound to move the floating plate 26, the connecting member 22, and the supporting plate 21 away from the two resilient members 60, until the supporting plate 21 abuts the operating plate 33. In this position, the limiting plane 225 abuts the limiting portion 231 and prevents the connecting member 22 from disengaging from the installation hole 351 due to inertia. After the punching assembly 10 is disengaged from the two rams 331, the flitch can be removed from the floating plate 26. The stamping die returns to an initial state.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A stamping die comprising:
a bracket;
a resilient member secured to the bracket;
a floating plate;
a supporting plate secured to the resilient member;
a connecting member with a first end secured to the floating plate and a second end, opposite to the first end, abutting the supporting plate; and
a limiting member secured to the bracket;
wherein the connecting member defines a cutout, and the limiting member is partially received in the cutout; the supporting plate, the connecting member, and the floating plate are slidable relative to the bracket; and the limiting member is configured for preventing the connecting member and the floating plate from disengaging from the supporting plate and the bracket, when the connecting member and the floating plate are slid relative to the bracket.

2. The stamping die of claim 1, wherein the connecting member defines the cutout to form a blocking plane and a limiting plane; the limiting member comprises a limiting portion, and a part of the limiting portion is received in the cutout; and the limiting plane is located between the limiting portion and the supporting plate.

3. The stamping die of claim 2, wherein the blocking plane abuts an outer surface of the limiting portion to prevent the connecting member from rotating relative to the limiting member.

4. The stamping die of claim 2, wherein the limiting plane is substantially perpendicular to the blocking plane.

5. The stamping die of claim 2, wherein the bracket comprises a base, two supporting blocks secured to the base, an operating plate, and an installation plate secured to the operating plate; the resilient member is secured to the base and located between the two supporting blocks; the supporting plate is located between the two supporting blocks; the installation plate is located between the floating plate and the operating plate; and the connecting member abuts the supporting plate through the installation plate and the operating plate.

6. The stamping die of claim 5, wherein the installation plate defines an installation hole and a mounting hole; the installation hole extends out of the operating plate; the mounting hole extends to the operating plate; and the connecting member is slidably received in the installation hole, and the limiting member is secured to the mounting hole.

7. The stamping die of claim 6, wherein a part of the installation hole communicates with a part of the mounting hole, and the limiting portion is received in the part of the mounting hole.

8. The stamping die of claim 1, further comprising a mounting member, wherein the mounting member is secured to the connecting member through the floating plate.

9. The stamping die of claim 8, wherein the floating plate defines a though hole, the connecting member defines a threaded hole, and the mounting member is engaged in the through hole and the threaded hole.

10. The stamping die of claim 1, wherein the limiting member is a screw.

11. A stamping die comprising:
a bracket;
a resilient member secured to the bracket;
a floating plate;
a supporting plate secured to the resilient member;
a connecting member with a first end secured to the floating plate and a second end, opposite to the first end, abutting the supporting plate; and
a limiting member secured to the bracket;
wherein the connecting member defines a cutout to form a blocking plane and a limiting plane connected to the blocking plane, and the limiting member abuts the blocking plane and is partially received in the cutout; the supporting plate, the connecting member, and the floating plate are slidable relative to the bracket; and the limiting member blocks the connecting member and the floating plate to disengage from the supporting plate and the bracket when the connecting member and the floating plate are slid relative to the bracket.

12. The stamping die of claim 11, wherein the limiting plane is substantially perpendicular to the blocking plane.

13. The stamping die of claim 11, wherein the limiting member comprises a limiting portion, and a part of the limiting portion is received in the cutout; and the limiting plane is located between the limiting portion and the supporting plate.

14. The stamping die of claim 13, wherein the blocking plane abuts an outer surface of the limiting portion to prevent the connecting member from rotating relative to the limiting member.

15. The stamping die of claim 13, wherein the bracket comprises a base, two supporting blocks secured to the base, an operating plate, and an installation plate secured to the operating plate; the resilient member is secured to the base and located between the two supporting blocks; the supporting plate is located between the two supporting blocks; the installation plate is located between the floating plate and the operating plate; and the connecting member abuts the supporting plate through the installation plate and the operating plate.

16. The stamping die of claim 15, wherein the installation plate defines an installation hole and a mounting hole; the installation hole extends out of the operating plate; the mounting hole extends to the operating plate; and the connecting member is slidably received in the installation hole, and the limiting member is secured to the mounting hole.

17. The stamping die of claim 16, wherein a part of the installation hole communicates with a part of the mounting hole, and the limiting portion is received in the part of the mounting hole.

18. The stamping die of claim 11, further comprising a mounting member, wherein the mounting member is secured to the connecting member through the floating plate.

19. The stamping die of claim 18, wherein the floating plate defines a though hole, the connecting member defines a threaded hole, and the mounting member is engaged in the through hole and the threaded hole.

20. The stamping die of claim 11, wherein the limiting member is a screw.
